(19) United States
(12) Patent Application Publication
(10) Pub. No.: US 2025/0290685 A1
(43) Pub. Date: Sep. 18, 2025

(54) REFRIGERATOR AND CONTROL METHOD THEREOF

(71) Applicant: SAMSUNG ELECTRONICS CO., LTD., Suwon-si (KR)

(72) Inventors: Dongo YANG, Suwon-si (KR); Sangyoul CHA, Suwon-si (KR); Sungbok KO, Suwon-si (KR); Jaehee BAEK, Suwon-si (KR); Hoon SHIM, Suwon-si (KR); Wonjae YOON, Suwon-si (KR); Changhak LIM, Suwon-si (KR); Hansol CHOI, Suwon-si (KR)

(73) Assignee: SAMSUNG ELECTRONICS CO., LTD., Suwon-si (KR)

(21) Appl. No.: 19/222,171

(22) Filed: May 29, 2025

Related U.S. Application Data
(63) Continuation of application No. PCT/KR2023/017271, filed on Nov. 1, 2023.

(30) Foreign Application Priority Data
Dec. 28, 2022 (KR) 10-2022-0187766

(51) Int. Cl. F25D 21/00; F25D 21/08

(52) U.S. Cl. CPC F25D 21/006; F25D 21/08; F25D 2400/361

(57) ABSTRACT

A refrigerator and a method of controlling the same. The refrigerator including a door, a communication unit, a heat exchanger, a defrost heater, and at least one processor, wherein the at least one processor is configured to determine a first time period during which the refrigerator is unused based on an opening and closing pattern of the door during the first time period, control the communication unit to receive sleep pattern information from a smart device, control the communication unit to transmit, to a server, the first time period and the sleep pattern information, control the communication unit to receive, from the server, a second time period obtained by calibrating the first time period based on the sleep pattern information, and determine an operation start time of the defrost heater based on a cooling duration of the heat exchanger and the second time period.

### CROSS-REFERENCE TO RELATED APPLICATION(S)

This application is a continuation application, claiming priority under § 111(a), of International Application No. PCT/KR2023/017271, filed on Nov. 1, 2023, which is based on and claims the benefit of Korean Patent Application No.: 10-2022-0187766, filed Dec. 28, 2022, in the Korean Intellectual Property Office, the disclosures of which are incorporated by reference herein in their entireties.

### TECHNICAL FIELD

Embodiments of the present disclosure relate to a refrigerator and a method of controlling the same.

### BACKGROUND ART

A refrigerator is a device that keeps food fresh in a storage compartment that is maintained in a low temperature state. The refrigerator may include a storage compartment and a cooling compartment. The storage compartment may include a door that isolates the storage compartment from the outside while allowing a user to take out food. The cooling compartment may supply cold air to the storage compartment to maintain the storage compartment in a low temperature state. The cooling compartment may include a heat exchanger that cools air to produce cold air. The cooling compartment may include a defrost heater for removing frost that is formed on the heat exchanger.

The defrost heater may be operated after cooling is performed in the heat exchanger for a certain period of time. In a refrigerator according to the related art, the defrost heater is operated when a time condition under which the defrost heater operates is satisfied. A temperature inside the refrigerator may rise while the defrost heater operates. When a user opens the door while the internal temperature of the refrigerator rises due to an operation of the defrost heater, the user may misunderstand that the internal temperature of the refrigerator has risen due to performance degradation or failure of the refrigerator.

### DISCLOSURE OF INVENTION

### Solution to Problem

A refrigerator according to an embodiment of the present disclosure may include a door, a communication unit, a heat exchanger, a defrost heater, and at least one processor. The at least one processor may be configured to determine a first time period during which the refrigerator is unused based on an opening and closing pattern of the door during the first time period. The at least one processor may be configured to control the communication unit to receive sleep pattern information from a smart device. The at least one processor may be configured to control the communication unit to transmit, to a server, the first time period and the sleep pattern information. The at least one processor may be configured to control the communication unit to receive, from the server, a second time period obtained by calibrating the first time period based on the sleep pattern information. The at least one processor may be configured to control the communication unit to determine an operation start time of the defrost heater based on a cooling duration of the heat exchanger and the second time period.

A method of controlling a refrigerator according to an embodiment may include determining a first time period during which the refrigerator is unused based on an opening and closing pattern of the door during the first time period. The method of controlling the refrigerator may include receiving sleep pattern information from the smart device. The method of controlling the refrigerator may include transmitting, to the server, information on the first time period and the sleep pattern information. The method of controlling the refrigerator may include receiving, from the server, the second time period obtained by calibrating the first time period based on the sleep pattern information. The method of controlling the refrigerator may include determining an operation start time of the defrost heater of the refrigerator based on a cooling duration of the heat exchanger of the refrigerator and the second time period.

### BRIEF DESCRIPTION OF DRAWINGS

FIG. 1 is a diagram illustrating a system including a refrigerator, a server, and a smart device according to an embodiment of the present disclosure.

FIG. 2 is a block diagram illustrating a refrigerator according to an embodiment of the present disclosure.

FIG. 3 is a perspective view of a refrigerator according to an embodiment of the present disclosure.

FIG. 4 is a side view of a refrigerator according to an embodiment of the present disclosure.

FIG. 5 is a diagram showing a heat exchanger according to an embodiment of the present disclosure.

FIG. 6 is a flowchart illustrating a method of controlling a refrigerator according to an embodiment of the present disclosure.

FIG. 7 is a graph showing an opening and closing pattern of a door according to an embodiment of the present disclosure.

FIG. 8 is a flowchart illustrating a method by which a refrigerator obtains and transmits a first time period and sleep pattern information according to an embodiment of the present disclosure.

FIG. 9 is a flowchart illustrating a method of determining an operation start time of a defrost heater of a refrigerator according to an embodiment of the present disclosure.

### MODE FOR THE INVENTION

The terms used in the present disclosure will be briefly described, and an embodiment of the present disclosure will be described in detail.

The terms used in the present disclosure are selected from the most widely used general terms possible while considering the functions of the present disclosure, but may vary depending on the intention of engineers in the field, precedents, the emergence of new technologies, and the like. In certain cases, there are terms arbitrarily selected by the applicant, and in such cases, their meanings are described in detail in the corresponding description of an embodiment of the present disclosure. Therefore, the terms used in the present disclosure need to be defined based on the meaning of the terms and the overall content of the present disclosure, rather than simply the names of the terms.

In the present disclosure, the expression “at least one of a, b or c” may refer to “a”, “b”, “c”, “a and b”, “a and c”, “b and c”, “all of a, b and c”, or variations thereof.

Throughout the present disclosure, unless explicitly described to the contrary, the word “comprise (include)” and variations such as “comprises (includes)” or “comprising (including)”, will be understood to imply the inclusion of stated elements but not the exclusion of any other elements. The terms such as “ . . . unit” or “module” disclosed in the present disclosure mean units for processing at least one function or operation, which may be implemented by hardware, software, or a combination thereof.

Hereinafter, embodiments of the present disclosure are described in detail such that those of skill in the art may easily implement the same with reference to the accompanying drawings. However, an embodiment of the present disclosure may be implemented in various different forms and is not limited to the embodiments described herein. To clearly explain an embodiment of the present disclosure in the drawings, portions that are not related to explanation are omitted, and similar portions are given similar drawing reference numerals throughout the present disclosure.

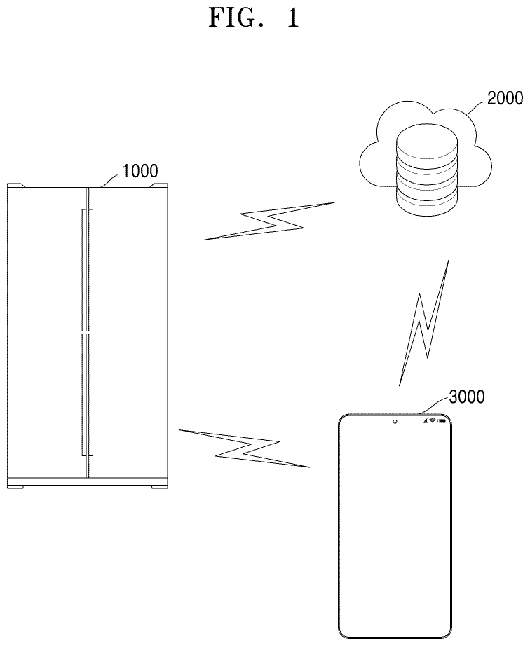

FIG. 1 is a diagram illustrating a system including a refrigerator 1000, a server 2000, and a smart device 3000 according to an embodiment of the present disclosure.

The refrigerator 1000 may be an electronic device (or home appliance) that refrigerates or freezes an object related to food. For example, the refrigerator 1000 may store food, medicine, alcoholic liquor, or cosmetics. The refrigerator 1000 may include a storage compartment for storing an object related to food. For example, the storage compartment of the refrigerator 1000 may store food (e.g., fresh food such as fruits and vegetables, cooked food, processed products, seasonings, or retort food), containers for side dishes or food (e.g., translucent containers, transparent containers, or opaque containers), beverages (e.g., raw water, carbonated water, yogurt, coffee, or milk), canned food, sauces (e.g., ketchup, mayonnaise, salad dressing, or steak sauce), medicines, alcoholic liquor, and cosmetics. The storage compartment of the refrigerator 1000 may be maintained in a constant low temperature state. For example, from among the storage compartments of the refrigerator 1000, a refrigerating chamber may be maintained at a temperature of about 1° C. or higher and about 10° C. or lower. For example, from among the storage compartments of the refrigerator 1000, a freezing chamber may be maintained at a temperature of about −30° C. or higher and about −15° C. or lower. Accordingly, food may be kept fresh in the storage compartment of the refrigerator 1000.

The refrigerator 1000 may collect state information related to a state of the storage compartment. For example, the refrigerator 1000 may collect temperature information related to a temperature fluctuation status of the storage compartment over a specified period of time. The refrigerator 1000 may distinguish time periods related to usage of the storage compartment. For example, the refrigerator 1000 may distinguish between a usage time period during which a user uses the refrigerator 1000 and a non-use time period during which the user does not use the refrigerator 1000 for a specified period of time.

The refrigerator 1000 may establish a wireless communication connection with the server 2000 and the smart device 3000. The refrigerator 1000 may receive information from the server 2000 or the smart device 3000 or transmit information to the server 2000 or the smart device 3000. For example, the refrigerator 1000 may receive sleep pattern information from the smart device 3000. The refrigerator 1000 may transmit, to the server 2000, information on the non-use time period and the sleep pattern information.

The server 2000 may include an artificial intelligence (AI) processor. The AI processor may train an artificial neural network to generate an AI model related to a control method of the refrigerator 1000. For example, the AI processor may generate a mathematical model of connection between neurons constituting an artificial neural network to make optimal decision while changing a weight applied to input data based on the input data to train the artificial neural network. The server 2000 may include a web storage or cloud server that performs a storage function on the Internet.

The server 2000 may communicate with the refrigerator 1000 or the smart device 3000 through a communication interface for communicating with an external device. The refrigerator 1000 may access the server 2000 by transmitting, to the server 2000, identification information of the refrigerator 1000 or identification information (login information) of the user and authenticating the identification information of the refrigerator 1000 or the identification information of the user from the server 2000.

The server 2000 may process information received from the refrigerator 1000. The server 2000 may generate information required for the refrigerator 1000 based on information received from the refrigerator 1000. For example, the server 2000 may generate a time period obtained by more accurately calibrating the non-use time period based on the non-use time period and sleep pattern information received from the refrigerator 1000. The server 2000 may transmit the calibrated time period to the refrigerator 1000.

The smart device 3000 may be a device connected to the refrigerator 1000 with the same account information as the refrigerator 1000. The smart device 3000 may be connected directly to the refrigerator 1000 through a short-range communication link or may be indirectly connected to the refrigerator 1000 through the server 2000.

The smart device 3000 may be implemented in various forms. For example, the smart device 3000 may include a smart phone, a laptop computer, a tablet personal computer (PC), an e-book terminal, a digital broadcasting terminal, personal digital assistants (PDA), a portable multimedia player (PMP), a digital camera, a navigation system, and an MP3 player. For example, the smart device 3000 may be a wearable device to be worn by a user. For example, the wearable device may include at least one of an accessory-type device (e.g., a smart watch, smart glasses, a ring, a bracelet, an anklet, a necklace, or a contact lens), a head mounted device (HMD), a fabric or clothing-integrated device (e.g., an electronic garment), a body-attached device (e.g., a skin pad), or an implantable device (e.g., an implantable circuit). Hereinafter, for convenience of descriptions, an example in which the smart device 3000 is a smart phone will be described.

The smart device 3000 may measure an activity time period during which the user is awake and a sleep time period during which the user sleeps. The smart device 3000 may analyze a trend of the activity time period and sleep time period for a certain period of time. The smart device 3000 may generate sleep pattern information of the user based on the trend of the activity time period and the sleep time period. The smart device 3000 may transmit the generated sleep pattern information to the refrigerator 1000.

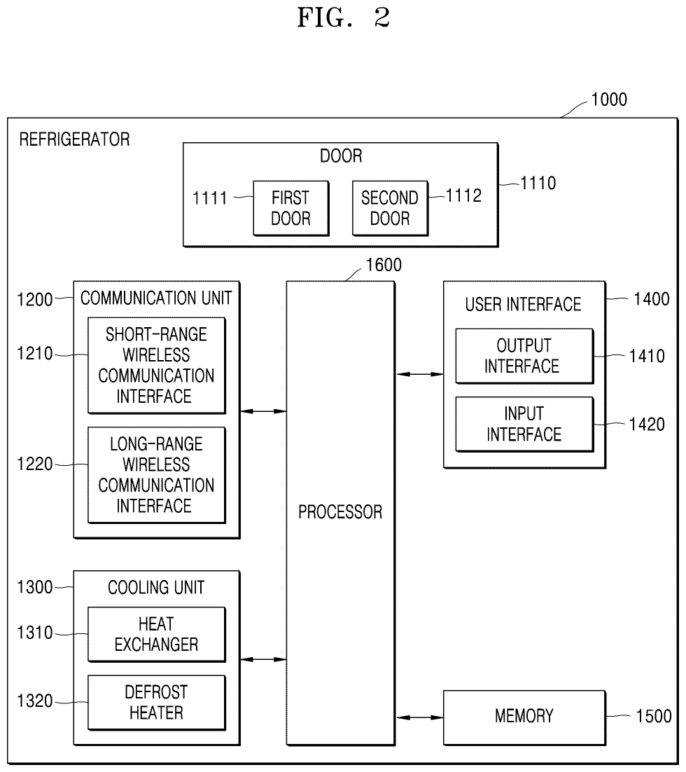

Hereinafter, components constituting the refrigerator 1000 will be described with reference to FIG. 2.

FIG. 2 is a block diagram illustrating the refrigerator 1000 according to an embodiment of the present disclosure. The refrigerator 1000 according to an embodiment may include a door 1110, a communication unit 1200, a cooling unit 1300, a user interface 1400, a memory 1500, and at least one processor 1600.

The door 1110 may isolate the storage compartment of the refrigerator 1000 from the outside. The door 1110 may be installed on a front surface of the refrigerator 1000 to be opened and closed by a user to take out food. The door 1110 may include a first door 1111 installed on a front left side of the refrigerator 1000 and a second door 1112 installed on a front right side of the refrigerator 1000.

The communication unit 1200 may establish a wireless communication connection with the server 2000 and the smart device 3000. The communication unit 1200 may include a short-range wireless communication interface 1210 and a long-range wireless communication interface 1220. For example, the short-range wireless communication interface 1210 may include a Bluetooth communication unit, a Bluetooth low energy (BLE) communication unit, a near field communication interface, a Wi-Fi communication unit, a WLAN communication unit, a Zigbee communication unit, an Infrared Data Association (IrDA) communication unit, a Wi-Fi direct (WFD) communication unit, an ultra wide band (UWB) communication unit, and an Ant+ communication unit. For example, the long-range wireless communication interface 1220 may include the Internet, a computer network (e.g., LAN or WAN), and a mobile communication unit. For example, a mobile communication unit may include a 3rd generation (3G) module, a 4th generation (4G) module, a long term evolution (LTE) module, a 5th generation (5G) module, a 6th generation (6G) module, an NB-IoT module, and an LTE-M module. The mobile communication unit may transmit and receive a radio signal with the server 2000 and the smart device 3000 over a mobile communication network. The radio signal may include various forms of data according to transmission and reception of a voice call signal, a video call signal, or a text/multimedia message.

The cooling unit 1300 may maintain the storage compartment of the refrigerator 1000 in a low temperature state. The cooling unit 1300 may supply cold air to the storage compartment. The cooling unit 1300 may include a heat exchanger 1310 and a defrost heater 1320.

The heat exchanger 1310 may generate cold air. The heat exchanger 1310 may allow a refrigerant and air to flow such that heat exchange occurs between the refrigerant and air. The heat exchanger 1310 may cool air through heat exchange between the refrigerant and air.

The defrost heater 1320 may remove frost formed on the heat exchanger 1310. A surface of the heat exchanger 1310 in which heat exchange occurs is in a low temperature state, and thus frost may be formed on the surface of the heat exchanger 1310. The defrost heater 1320 may heat the surface of the heat exchanger 1310 to remove frost formed on the surface of the heat exchanger 1310.

The user interface 1400 may receive a user input from a user and provide output information to the user. The user interface 1400 may include an output interface 1410 and an input interface 1420. The output interface 1410 may include a display unit and an audio output unit. The display unit may visually display information about an operation of the refrigerator 1000. For example, the display unit may output a graphical user interface (GUI) that corresponds to temperature information of the storage compartment of the refrigerator 1000. For example, the display unit may visually display information about a cooling mode of the storage compartment, such as a normal mode and a power cooling mode. The audio output unit may output an audio signal related to a state of the refrigerator 1000. For example, the audio output unit may output a warning sound indicating that the door 1110 of the refrigerator 1000 is open when the door 1110 is open for a certain period of time (e.g., 10 seconds, 15 seconds, or 20 seconds) or more.

The input interface 1420 may receive a user input from the user. For example, the input interface 1420 may include at least one of a key pad, a dome switch, a touch pad (contact-type electrostatic capacitance method, pressure-type resistive film method, infrared detection method, surface ultrasonic conduction method, integral tension measurement method, piezo effect method, or the like), a jog wheel, or a jog switch. The input interface 1420 may be installed on a front surface of the door 1110 of the refrigerator 1000. For example, the input interface 1420 may be installed on a central portion of the front surface of the door 1110 of the refrigerator 1000. The input interface 1420 may receive a touch input for the user to manipulate an operation of the refrigerator 1000. For example, the input interface 1420 may receive a touch input for the user to adjust a set temperature of the storage compartment of the refrigerator 1000.

The memory 1500 may store a program for processing and control operations of the at least one processor 1600. Programs stored in the memory 1500 may be classified into a plurality of modules according to functions thereof. The memory 1500 may store input/output data (e.g., temperature information of the storage compartment of the refrigerator 1000, and an opening and closing pattern of the door 1110 of the refrigerator 1000). The memory 1500 may store an AI model. The memory 1500 may include at least one type of storage medium of flash memory type, a hard disk type, a multimedia card micro type, card type memory (e.g., SD or XD memory), random access memory (RAM), static random access memory (SRAM), read-only memory (ROM), electrically erasable programmable read-only memory (EEPROM), programmable read-only memory (PROM), magnetic memory, a magnetic disk, or an optical disk.

The at least one processor 1600 may control the overall operation of the refrigerator 1000. For example, the at least one processor 1600 may include a central processing unit (CPU), an application processor (AP), a graphic processing unit (GPU), and an artificial intelligence (AI) processor. The AI processor may be manufactured in the form of a dedicated hardware chip or may be manufactured as a portion of a central processing unit, an application processor, or a dedicated graphics processor and installed in the refrigerator 1000. The AI processor may be designed with a hardware structure specialized for processing an AI model. The AI processor may generate an AI model through learning. For example, the AI processor may generate an AI model having a predefined operation rule set to perform a desired characteristic (or purpose) by learning from a large amount of learning data by using a learning algorithm. The AI model may include a plurality of neural network layers. Each of the plurality of neural network layers may have a plurality of weight values. Each of the plurality of neural network layers may perform a neural network operation through an operation between the operation result of a previous layer and the plurality of weight values.

The at least one processor 1600 of the refrigerator 1000 according to an embodiment may determine a first time period during which the refrigerator 1000 is not used based on an opening and closing pattern of the door 1110 during a first period of time. The at least one processor 1600 may control the communication unit 1200 to receive sleep pattern information from the smart device 3000. The at least one processor 1600 may control the communication unit 1200 to transmit, to the server 2000, the first time period and the sleep pattern information. The at least one processor 1600 may control the communication unit 1200 to receive, from the server 2000, a second time period obtained by calibrating the first time period based on the sleep pattern information. The at least one processor 1600 may determine an operation start time of the defrost heater 1320 based on a cooling duration of the heat exchanger 1310 and the second time period.

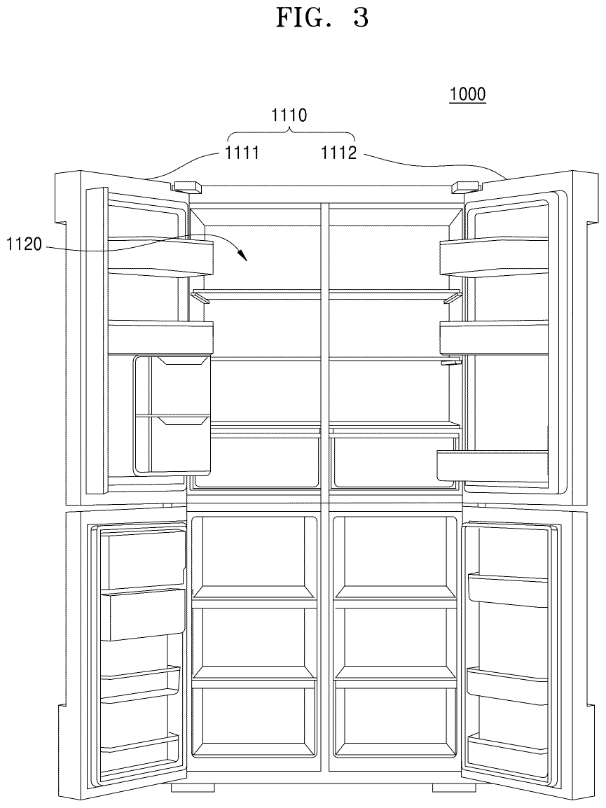

Hereinafter, a physical structure constituting an external form of the refrigerator 1000 will be described with reference to FIG. 3.

FIG. 3 is a perspective view of the refrigerator 1000 according to an embodiment of the present disclosure. The refrigerator 1000 may include the door 1110 and a storage compartment 1120. The door 1110 may include a first door 1111 and a second door 1112.

The door 1110 may be placed on a front surface of the refrigerator 1000. The door 1110 may be rotatably connected to a main body defining an outer appearance of the refrigerator 1000 to open and close an open front surface of the storage compartment 1120. The door 1110 may be rotatably coupled to the main body of the refrigerator 1000 by using a hinge structure. For example, the hinge structure may be formed at a left corner and right corner of the refrigerator 1000. The first door 1111 may open the front left side of the refrigerator 1000 by rotating around the left corner of the refrigerator 1000 as an axis. The second door 1112 may open the front right side of the refrigerator 1000 by rotating around the right corner of the refrigerator 1000 as an axis.

The storage compartment 1120 may be provided such that a front surface is open inside the main body of the refrigerator 1000. The storage compartment 1120 may be divided into upper and lower and left and right sides by internal partitions. For example, the storage compartment 1120 may be divided into a freezing chamber on the left and a refrigerating chamber on the right by internal partitions. Inside the storage compartment 1120, a plurality of shelves and storage containers may be provided to store food, and the like. The storage compartment 1120 may be maintained in a low temperature state by the cooling unit 1300. The main body of the refrigerator 1000 may include an insulating material to reduce power consumption for maintaining the low temperature state of the storage compartment 1120.

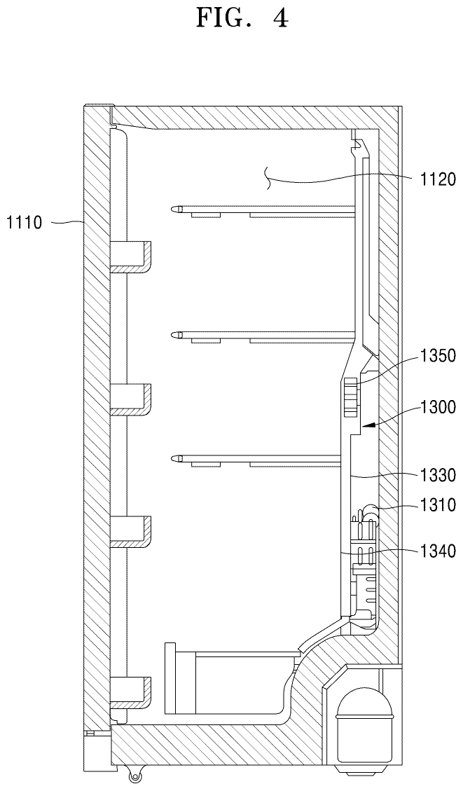

Hereinafter, a structure that is placed inside the refrigerator 1000 and implements a cooling function of the refrigerator 1000 will be described with reference to FIG. 4.

FIG. 4 is a side view of the refrigerator 1000 according to an embodiment of the present disclosure. The storage compartment 1120 may be maintained closed by the door 1110. The cooling unit 1300 may supply cold air to the storage compartment 1120 to maintain the storage compartment 1120 in a low temperature state. The cooling unit 1300 may include a heat exchanger 1310, an intake duct 1330, an exhaust duct 1340, and a fan 1350.

The heat exchanger 1310 may generate cold air through a refrigeration cycle. The refrigeration cycle may be a process of cooling air by using a refrigerant. The refrigeration cycle may include a condenser that converts a compressed gaseous refrigerant into a liquid refrigerant, an expander that reduces a pressure of the liquid refrigerant, and an evaporator that vaporizes the reduced pressure liquid refrigerant. The heat exchanger 1310 may supply, to the storage compartment 1120, cold air generated through the refrigeration cycle. The refrigerator 1000 may include a compressor for compressing a refrigerant, which is a working fluid of a refrigeration cycle, separately from the heat exchanger 1310.

The intake duct 1330, the exhaust duct 1340, and the fan 1350 may form an air flow passage within the cooling unit 1300. The intake duct 1330 may form an air inlet passage through which air from the storage compartment 1120 is introduced and passes through the heat exchanger 1310. The exhaust duct 1340 may form an air exhaust passage for supplying cold air passing through the heat exchanger 1310 to the storage compartment 1120. The fan 1350 may form a flow of air inside the intake duct 1330 and the exhaust duct 1340.

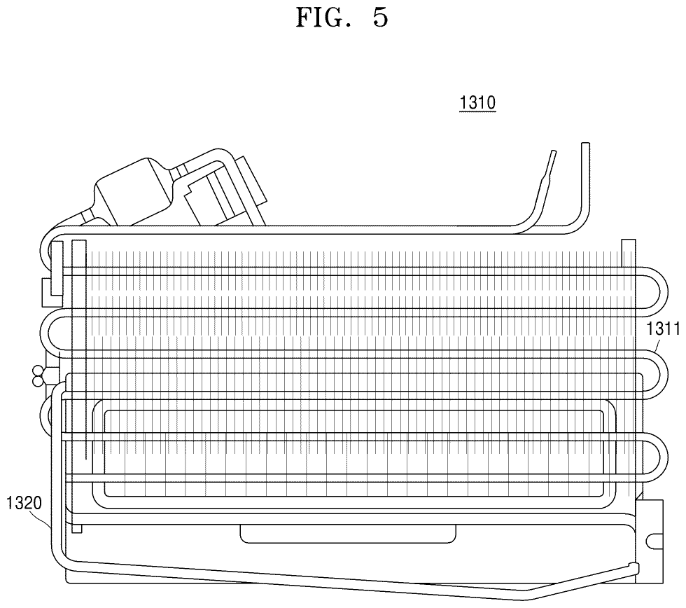

Hereinafter, a structure of the heat exchanger 1310 that generates cold air in the refrigerator 1000 will be described with reference to FIG. 5.

FIG. 5 is a diagram showing the heat exchanger 1310 according to an embodiment of the present disclosure. The heat exchanger 1310 may include a tube 1311. The defrost heater 1320 may be installed in the heat exchanger 1310.

The tube 1311 may allow a refrigerant to flow. The tube 1311 may be placed in a direction perpendicular to a direction in which air flows. The tube 1311 may have a structure that is folded a plurality of times to cross a plurality of times in a direction of air flow. The tube 1311 may allow heat exchange between a refrigerant and air while the refrigerant and air perpendicularly meet each other inside the heat exchanger 1310. A plurality of fins may be arranged on an outer surface of the tube 1311. The plurality of fins may facilitate heat exchange between the refrigerant flowing within the tube 1311 and the air passing through the heat exchanger 1310.

The defrost heater 1320 may remove frost formed on the heat exchanger 1310. The defrost heater 1320 may have a pipe structure that transports heat. The defrost heater 1320 may be placed to pass through at least one side portion of the heat exchanger 1310 and a lower portion of the heat exchanger 1310. For example, when the cooling unit 1300 is placed at a rear portion of the storage compartment 1120, the defrost heater 1320 may be placed to pass through a front portion of the heat exchanger 1310 and the lower portion of the heat exchanger 1310. For example, the defrost heater 1320 may be placed across the side and front portions of the heat exchanger 1310. When the defrost heater 1320 is operated, frost formed on a surface of the heat exchanger 1310 may be removed while transporting heat through a pipe of the defrost heater 1320.

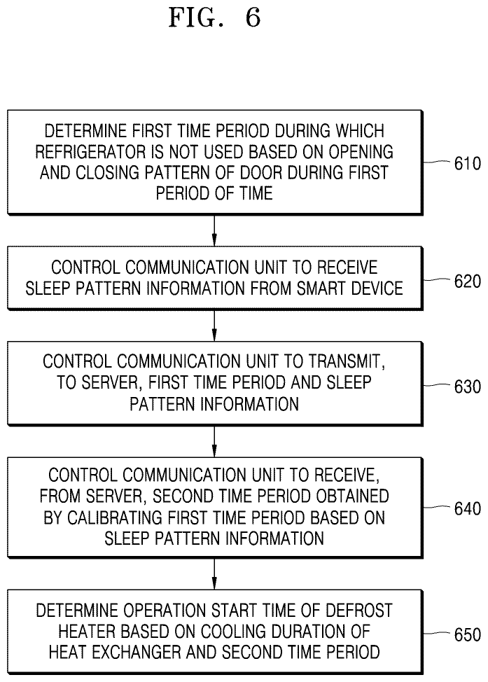

The defrost heater 1320 may be operated after cooling is performed in the heat exchanger 1310 for a certain period of time. In the refrigerator 1000 according to the related art, the defrost heater 1320 is operated when a time condition for operating the defrost heater 1320 is satisfied. The internal temperature of the refrigerator 1000 may rise while the defrost heater 1320 operates. When a user opens the door 1110 while the defrost heater 1320 operates and the internal temperature of the refrigerator 1000 rises, the user may misunderstand that the internal temperature of the refrigerator 1000 rises due to performance degradation or failure of the refrigerator 1000. To reduce user misunderstanding and improve the refrigeration efficiency of the refrigerator 1000, it is necessary to control an operating timing of the defrost heater 1320. Hereinafter, a method of controlling the refrigerator 1000 to determine the operating timing of the defrost heater 1320 will be described with reference to FIG. 6.

FIG. 6 is a flowchart illustrating a method of controlling the refrigerator 1000 according to an embodiment of the present disclosure.

In operation 610, the at least one processor 1600 of the refrigerator 1000 according to an embodiment may determine a first time period during which the refrigerator 1000 is not used based on an opening and closing pattern of the door 1110 during a first period of time. The at least one processor 1600 may obtain an opening and closing pattern of the door 1110 during the first period of time. The at least one processor 1600 may determine a time period during which the refrigerator 1000 is not used based on the obtained opening and closing pattern of the door 1110.

In an embodiment, the opening and closing pattern of the door 1110 may include information about a frequency of opening and closing of the door 1110 by time of day. The first period of time may be set as a period of time during which the number of times the door 1110 is opened and closed is to be collected by time of day. The first period of time may be set as a period of time for calculating the number of times the door 1110 is opened and closed during the day and a time period during which the door 1110 is mainly opened and closed. For example, the first period of time may be 5 days or more to 7 days or less, including weekdays and weekends. The number of times the door 1110 is opened and closed and the time period during which the door 1110 is mainly opened and closed on weekdays may be different from the number of times the door 1110 is opened and closed and the time period during which the door 1110 is mainly opened and closed on weekends. When the first period of time includes weekdays and weekends, the opening and closing pattern of the door 1110 may be obtained by reflecting both the number of times the door 1110 is opened and closed and the time period during which the door 1110 is mainly opened and closed on each of a weekday and a weekend.

In an embodiment, the at least one processor 1600 may obtain the opening and closing pattern of the door 1110 on a daily basis during the first period of time. For example, when the first period of time is set to 5 days, the at least one processor 1600 may obtain an opening and closing pattern of the door 1110 on a first day, an opening and closing pattern of the door 1110 on a second day, an opening and closing pattern of the door 1110 on a third day, an opening and closing pattern of the door 1110 on a fourth day, and an opening and closing pattern of the door 1110 on a fifth day.

In an embodiment, the at least one processor 1600 may determine a first time period during which the user does not use the refrigerator 1000 based on the opening and closing patterns of the door 1100 obtained on a daily basis. For example, the at least one processor 1600 may add the number of times the door 1100 is opened and closed on a daily basis in the opening and closing patterns of the door 1110 obtained on a daily basis to determine, as a first time period, a time period with the lowest number of openings and closings. The at least one processor 1600 may analyze the opening and closing patterns of the door 1110 obtained on a daily basis by using an AI model to determine the first time period.

In operation 620, the at least one processor 1600 of the refrigerator 1000 according to an embodiment may control the communication unit 1200 to receive sleep pattern information from the smart device 3000. The smart device 3000 may calculate an active time period of a user and an inactive time period due to sleep or the like to generate the sleep pattern information. The at least one processor 1600 may control the communication unit 1200 to receive the sleep pattern information generated by the smart device 3000.

In an embodiment, the at least one processor 1600 may control the communication unit 1200 to establish a wireless communication connection with the smart device 3000. For example, the at least one processor 1600 may control the communication unit 1200 to establish a Bluetooth low energy (BLE) communication connection with the smart device 3000.

In an embodiment, the at least one processor 1600 may control the communication unit 1200 to request transmission of the sleep pattern information to the smart device 3000. For example, the at least one processor 1600 may control the communication unit 1200 to transmit, to the smart device 3000, a request signal requesting transmission of the sleep pattern information at a specified interval. The specified interval may be 1 day. For example, the at least one processor 1600 may control the communication unit 1200 to transmit a request signal to the smart device 3000 in response to a user input. The user input may be a touch input entered into the input interface 1420 provided in the door 1110 of the refrigerator 1000. However, the user input is not limited thereto and may be a touch input entered into the smart device 3000, and the smart device 3000 may transmit, to the communication unit 1200, a notification signal notifying that the sleep pattern information is to be transmitted. In this case, the at least one processor 1600 may be prepared to receive the sleep pattern information based on the notification signal.

In an embodiment, the at least one processor 1600 may receive the sleep pattern information from the smart device 3000 by using the communication unit 1200. For example, the at least one processor 1600 may control the communication unit to receive the sleep pattern information from the smart device 3000 that has established a BLE communication connection. For example, the at least one processor 1600 may control the communication unit 1200 to receive the sleep pattern information from the smart device 3000 at a specified interval. The specified interval may be 1 day. For example, the at least one processor 1600 may control the communication unit 1200 to receive the sleep pattern information from the smart device 3000 in response to a user input. The user input may be a touch input entered into the input interface 1420 provided in the door 1110 of the refrigerator 1000. However, the user input is not limited thereto and may be a touch input entered into the smart device 3000, and the at least one processor 1600 may receive the sleep pattern information by a touch input entered into the smart device 3000.

In operation 630, the at least one processor 1600 of the refrigerator 1000 according to an embodiment may control the communication unit 1200 to transmit, to the server 2000, the first time period and the sleep pattern information. The at least one processor 1600 may control the communication unit 1200 to establish a wireless communication connection with the server 2000. The at least one processor 1600 may control the communication unit 1200 to transmit, to the server 2000, the determined first time period and the sleep pattern information received from the smart device 3000.

In operation 640, the at least one processor 1600 of the refrigerator 1000 according to an embodiment of the present disclosure may control the communication unit 1200 to receive, from the server 2000, the second time period obtained by calibrating the first time period based on the sleep pattern information. The second time period may be a time period during which the refrigerator 1000 is not used, which is calculated more accurately by reflecting the sleep pattern information of the user. The server 2000 may generate the second time period by calibrating the first time period based on the sleep pattern information. The server 2000 may transmit the second time period to the refrigerator 1000. The at least one processor 1600 may control the communication unit 1200 to receive the second time period from the server 2000. Accordingly, the at least one processor 1600 may more accurately obtain a time period during which the user does not use the refrigerator 1000 by reflecting the sleep pattern information obtained from the smart device 3000.

In operation 650, the at least one processor 1600 of the refrigerator 1000 according to an embodiment may determine an operation start time of the defrost heater 1320 based on the cooling duration of the heat exchanger 1310 and the second time period. The cooling duration may be a time during which the heat exchanger 1310 continues to operate to generate cold air. During the cooling duration of the heat exchanger 1310, the defrost heater 1320 may be stopped from operating. The at least one processor 1600 may measure the cooling duration of the heat exchanger 1310. The at least one processor 1600 may calculate a first point in time at which the cooling duration of the heat exchanger 1310 ends.

In an embodiment, the at least one processor 1600 may determine whether to start an operation of the defrost heater 1320 at the first point in time when the cooling duration of the heat exchanger 1310 ends. The at least one processor 1600 may determine whether to start an operation of the defrost heater 1320 based on whether the first point in time is included in the second time period. The at least one processor 1600 may determine, as the first point in time, the operation start time of the defrost heater 1320 when the first point in time at which the cooling duration ends is included in the second time period. The at least one processor 1600 may determine, as the second point in time as a start point in time of the second time period, the operation start time of the defrost heater 1320 when the first point in time at which the cooing duration ends is not included in the second time period.

In an embodiment, the at least one processor 1600 may operate the defrost heater 1320 during at least a portion of the second time period during which the user does not use the refrigerator 1000. The at least one processor 1600 may operate the defrost heater 1320 to start a defrosting operation at an end time of the cooling duration of the heat exchanger 1310 when the end time falls a time period during which the user does not use the refrigerator 1000. The at least one processor 1600 may determine the operation start time of the defrost heater 1320 as a start time of a non-use time period during which the end time of the cooling duration of the heat exchanger 1310 is not the non-use time period during which the user does not use the refrigerator 1000. Accordingly, the at least one processor 1600 may operate the defrost heater 1320 during a time period during which the user does not use the refrigerator 1000, which may make the user unaware of a temperature rise in the storage compartment 1120 due to the operation of the defrost heater 1320, thereby reducing misunderstanding related to performance degradation or failure of the refrigerator 1000.

In an embodiment, the at least one processor 1600 may determine, as a second point in time after the first point in time, the operation start time of the defrost heater 1320 when the second point in time is reached before a threshold time after the first point in time. The threshold time may be the maximum time during which an operation of the defrost heater 1320 is to be delayed. The at least one processor 1600 may delay the operation start time of the defrost heater 1320 until a time period during which the user does not use the refrigerator 1000 when the time period during which the user does not use the refrigerator 1000 begins before the threshold time after the end time of the cooling duration of the heat exchanger 1310.

In an embodiment, the at least one processor 1600 may determine, as a second point in time before the first point in time, the operation start time of the defrost heater 1320 when the second point in time is reached after a threshold time after the first point in time. When a time period during which the user does not use the refrigerator 1000 begins after the threshold time after the end time of the cooling duration of the heat exchanger 1310, the at least one processor 1600 may start the defrosting operation early by operating the defrost heater 1320 during a previous non-use time period.

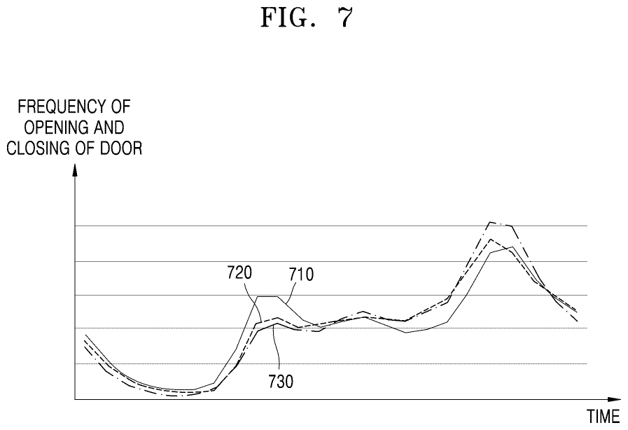

Hereinafter, opening and closing patterns of the door 1110 obtained during the first period of time to determine the first time period in operation 610 will be described with reference to FIG. 7.

FIG. 7 is a graph showing an opening and closing pattern of the door 1110 according to an embodiment of the present disclosure.

In an embodiment, the at least one processor 1600 may obtain the opening and closing pattern of the door 1110 during the first period of time. The opening and closing pattern of the door 1110 may include information about a frequency of opening and closing of the door 1110 by time of day. For example, the opening and closing pattern of the door 1110 may include information indicating an opening and closing frequency of the door 1110 by time from 0 to 24 o′clock.

In an embodiment, the at least one processor 1600 may obtain the opening and closing pattern of the door 1100 on a daily basis during the first period of time. For example, the at least one processor 1600 may obtain a first opening and closing pattern 710 of the door 1110 on a first day, a second opening and closing pattern 720 of the door 1110 on a second day, and a third opening and closing pattern 730 of the door 1110 on a third day. The first opening and closing pattern 710 may include information indicating the opening and closing frequency of the door 1110 by time from 0 to 24 o′clock on the first day. The second opening and closing pattern 720 may include information indicating the opening and closing frequency of the door 1110 by time from 0 to 24 o′clock on the second day. The third opening and closing pattern 730 may include information indicating the opening and closing frequency of the door 1110 by time from 0 to 24 o′clock on the third day.

In an embodiment, the at least one processor 1600 may determine a first time period during which the user does not use the refrigerator 1000 based on the opening and closing patterns of the door 1110 obtained on a daily basis. For example, the at least one processor 1600 may add the number of times the door 1110 is opened and closed for each time period in the first opening and closing pattern 710, the second opening and closing pattern 720, and the third opening and closing pattern 730 to determine, as the first time period, a time period with the lowest number of openings and closings. For example, when the number of openings and closings of the door 1100 for each time period may be added and the number of openings and closings from 3:00 AM to 6:00 AM is the lowest, the at least one processor 1600 may determine, as the first time period, a time period from 3:00 AM to 6:00 AM.

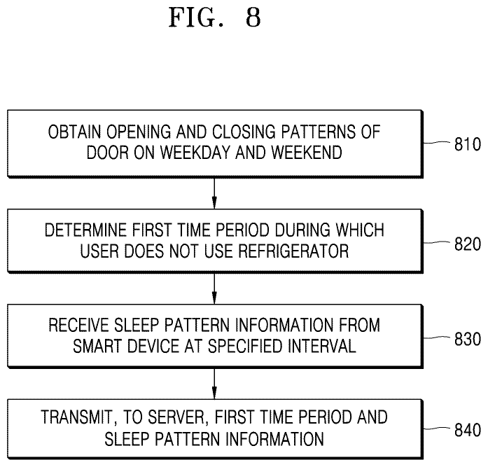

Hereinafter, a detailed method of obtaining the first time period and sleep pattern information from the refrigerator 1000 and transmitting the first time period and the sleep pattern information to the server 2000 will be described with reference to FIG. 8.

FIG. 8 is a flowchart illustrating a method by which a refrigerator 1000 obtains and transmits a first time period and sleep pattern information according to an embodiment of the present disclosure.

In operation 810, the refrigerator 1000 according to an embodiment may obtain opening and closing patterns of the door 1110 on weekdays and weekends. The time period and number of times the door 1110 of the refrigerator 1000 is opened and closed on weekdays may be different from the time period and number of times the door 1110 of the refrigerator 1000 is opened and closed on weekends. For example, on weekdays, the door 1110 of the refrigerator 1000 may be opened and closed mainly between 6:00 and 8:00 AM in the morning and between 5:00 and 9:00 PM in the evening, and the total number of times the door 1110 is opened and closed may be about 5 or more and 15 or less times. For example, on weekends, the door 1110 of the refrigerator 1000 may be opened and closed mainly between 8:00 and 11:00 AM, which is between breakfast and lunch, and between 7:00 and 10:00 PM, which is at night, and the number of times may be about 10 or more and 20 or less. The at least one processor 1600 of the refrigerator 1000 according to an embodiment may measure the time period and number of times the door 1110 is opened and closed on each of a weekday and a weekend. The at least one processor 1600 may measure the time period and number of times the door 1110 is opened and closed for 5 days or more to 7 days or less. The at least one processor 1600 may obtain the opening and closing pattern of the door 1110 based on the measured time period and number of times the door 1110 is opened and closed.

In operation 820, the refrigerator 1000 according to an embodiment may determine a first time period during which the user does not use the refrigerator 1000. The at least one processor 1600 of the refrigerator 1000 according to an embodiment may determine the first time period based on the opening and closing pattern of the door 1110. The at least one processor 1600 may determine, as the first time period, a time period with the lowest frequency of opening and closing the door 1110 in the opening and closing pattern of the door 1110. For example, the at least one processor 1600 may determine, as the first time period, a time period between 11:00 PM and 5:00 AM when the frequency of opening and closing the door 1110 is the lowest between 11:00 PM and 5:00 AM in the opening and closing pattern of the door 1110.

In operation 830, the refrigerator 1000 according to an embodiment may receive sleep pattern information from the smart device 3000 at a specified interval. The smart device 3000 may measure a sleep time of a user based on whether the user manipulates the smart device 3000. For example, when the user last operates the smart device 3000 between 11:10 PM and 11:20 PM and then does not operate the smart device 3000 and starts operating the smart device 3000 between 6:10 AM and 6:20 AM, the smart device 3000 may measure the sleep time as from 11:30 PM to 6:00 AM. The smart device 3000 may measure the sleep time of the user on a daily basis.

In an embodiment, the smart device 3000 may generate sleep pattern information of the user based on the measured sleep time. For example, when the smart device 3000 consecutively measures the sleep time of the user as from 11:30 PM to 6:00 AM for 5 or more and 7 days or less, the smart device 3000 may generate sleep pattern information indicating that the sleep pattern of the user is from 11:30 PM to 6:00 AM. The at least one processor 1600 of the refrigerator 1000 according to an embodiment may control the communication unit 1200 to receive sleep pattern information from the smart device 3000 at a specified interval. The specified interval may be an interval in which sleep pattern information of the smart device 3000 is required to calibrate the non-use time period of the refrigerator 1000. For example, the specified interval may be 5 days or more and 7 days or less.

In operation 840, the refrigerator 1000 according to an embodiment may transmit, to the server 2000, the first time period and the sleep pattern information. The at least one processor 1600 of the refrigerator 1000 according to an embodiment may transmit a request to the server 2000 to process the obtained first time period and the sleep pattern information received from the smart device 3000. The at least one processor 1600 may control the communication unit 1200 to transmit, to the server 2000, the first time period and the sleep pattern information. Accordingly, the server 2000 may calibrate the first time period based on the sleep pattern information. For example, the server 2000 may calibrate the first time period such that a time that is not included in the sleep pattern information during the first time period is excluded from the non-use time period. For example, when the first time period is from 11:00 PM to 5:00 AM and the sleep time according to sleep pattern information is from 11:30 PM to 6:00 AM, the server 2000 may calibrate the non-use time period to from 11:30 PM to 5:00 AM.

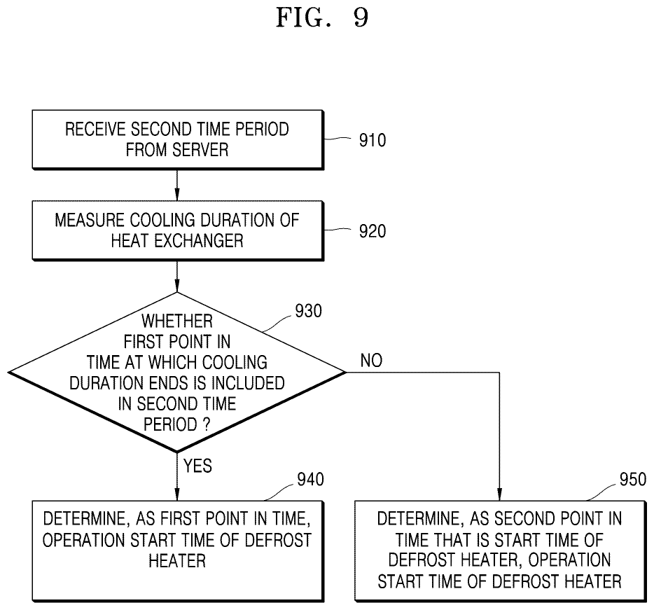

Hereinafter, a detailed method of determining an operation start time of the defrost heater 1320 will be described with reference to FIG. 9.

FIG. 9 is a flowchart illustrating a method of determining an operation start time of the defrost heater 1320 of the refrigerator 1000 according to an embodiment of the present disclosure.

In operation 910, the refrigerator 1000 according to an embodiment may receive the second time period from the server 2000. The second time period may be a time period during which the user does not use the refrigerator 1000, generated by the server 2000. For example, when the server 2000 calibrates the non-use time period to 11:30 PM to 5:00 AM, the second time period may be 11:30 PM to 5:00 AM. The at least one processor 1600 of the refrigerator 1000 according to an embodiment may control the communication unit 1200 to receive the second time period from the server 2000.

In operation 920, the refrigerator 1000 according to an embodiment may measure the cooling duration of the heat exchanger 1310. The cooling duration may be a set time for the heat exchanger 1310 to continue an operation of generating cold air and supplying the cold air to the storage compartment 1120. For example, the cooling duration may be set to about 20 hours or more and about 30 hours or less. The at least one processor 1600 of the refrigerator 1000 according to an embodiment may measure the cooling duration. For example, the at least one processor 1600 may measure that the cooling duration is 24 hours.

In operation 930, the refrigerator 1000 according to an embodiment may determine whether a first point in time at which the cooling duration ends is included in the second time period. The at least one processor 1600 of the refrigerator 1000 according to an embodiment may measure the cooling duration, which is a time for which the heat exchanger 1310 performs an operation of supplying cold air up to the present point in time, and a cooling remaining time, which is the remaining time for the heat exchanger 1310 to supply cold air to match the cooling duration. For example, the at least one processor 1600 may measure that the heat exchanger 1310 performs a cooling operation for 18 hours and that there are 6 hours remaining until the cooling duration ends. The at least one processor 1600 may calculate the first point in time at which the cooling duration ends based on the cooling remaining time. For example, the at least one processor 1600 may calculate the first point in time as a point in time 6 hours from the present. The at least one processor 1600 may proceed to operation 940 when the first point in time is included in the second time period (operation 930—YES). The at least one processor 1600 may proceed to operation 950 when the first point in time is not included in the second time period (operation 930—NO).

In operation 940, the refrigerator 1000 according to an embodiment may determine, as the first point in time, the operation start time of the defrost heater 1320. The first point in time at which the cooling duration ends may be included in the second time period during which the user does not use the refrigerator 1000. For example, when it is now 9:00 PM, the first point in time, which is 6 hours from now, may be 3:00 AM, which is included in the second time period during which the refrigerator 1000 is not used. The at least one processor 1600 of the refrigerator 1000 according to an embodiment may determine, as the first point in time, the operation start time of the defrost heater 1320 to start a defrosting operation at the first point in time when the first point in time is included in the second time period. For example, the at least one processor 1600 may determine, as 3:00 AM that is the first point in time, the operation start time of the defrost heater 1320. When the first point in time is included in the second time period, the user may not recognize that the temperature of the storage compartment 1120 rises due to an operation of the defrost heater 1320. Accordingly, the refrigerator 1000 and method of controlling the same according to the present disclosure may reduce user misunderstanding related to performance degradation or failure of the refrigerator 1000 and improve the refrigeration efficiency of the refrigerator 1000 by operating the defrost heater 1320 during a time period during which the user does not use the refrigerator 1000.

In operation 950, the refrigerator 1000 according to an embodiment may determine, as the second point in time that is a start time of the defrost heater 1320, the operation start time of the defrost heater 1320. The first point in time at which the cooling duration ends may not be included in the second time period during which the user does not use the refrigerator 1000. For example, when it is now 3:00 PM, the first point in time, which is 6 hours from now, may be 9:00 PM, which is not included in the second time period during which the refrigerator 1000 is not used. When the first point in time is not included in the second time period and a defrosting operation is started at the first point in time, the user may recognize that the temperature of the storage compartment 1120 rises due to the operation of the defrost heater 1320. The at least one processor 1600 of the refrigerator 1000 according to an embodiment may change the operation start time of the defrost heater 1320 to a second point in time. For example, the at least one processor 1600 may determine, as 11:30 PM, the operation start time of the defrost heater 1320. Accordingly, the refrigerator 1000 and method of controlling the same according to the present disclosure may reduce user misunderstanding related to performance degradation or failure of the refrigerator 1000 and improve the refrigeration efficiency of the refrigerator 1000 by operating the defrost heater 1320 during a time period during which the user does not use the refrigerator 1000 based on a user usage pattern of the refrigerator 1000. The refrigerator 1000 and method of controlling the same according to the present disclosure may more accurately calibrating the non-use time of the refrigerator 1000 of the user by using the sleep pattern information of the user received from a smart device, and thus the operation start time of the defrost heater 1320 may be determined to match the more accurate non-use time period, thereby reducing user misunderstanding related to performance degradation or failure of the refrigerator 1000 and improving the refrigeration efficiency of the refrigerator 1000.

In an embodiment, the at least one processor 1600 may determine, as a second point in time after the first point in time, the operation start time of the defrost heater 1320 when the second point in time is reached before a threshold time after the first point in time. The threshold time may be the maximum time during which an operation of the defrost heater 1320 is to be delayed. For example, the threshold time may be 10 hours. The at least one processor 1600 may delay the operation start time of the defrost heater 1320 until a time period during which the user does not use the refrigerator 1000 when the time period during which the user does not use the refrigerator 1000 begins before the threshold time after the end time of the cooling duration of the heat exchanger 1310. For example, when the first point in time is 9:00 PM, the second point in time, 11:30 PM, is reached 2 hours and 30 minutes after the threshold time, and thus the at least one processor 1600 may determine, as 11:30 AM, 2 hours and 30 minutes after the first point in time, the operation start time of the defrost heater 1320.

In an embodiment, the at least one processor 1600 may determine, as a second point in time before the first point in time, the operation start time of the defrost heater 1320 when the second point in time is reached after a threshold time after the first point in time. The at least one processor 1600 may start the defrosting operation early by operating the defrost heater 1320 during a previous non-use time period during which a time period during which the user does not use the refrigerator 1000 begins after the threshold time after the end time of the cooling duration of the heat exchanger 1310. For example, when the first point in time is 10:00 AM, the second point in time, 11:30 PM, is reached after 13:30 that is after the threshold time, and thus the at least one processor 1600 may determine, 11:30 PM yesterday, which is before the first point in time, the operation start time of the defrost heater 1320.

A refrigerator and method of controlling the same according to the present disclosure are to reduce user misunderstanding related to performance degradation or failure of the refrigerator and improve the refrigeration efficiency of the refrigerator by operating a defrost heater during a time period during which the user does not use the refrigerator based on the refrigerator usage pattern of the user.

The refrigerator and method of controlling the same according to the present disclosure are to obtain a more accurate time period during which the user does not use the refrigerator by using sleep pattern information of the user received from a smart device and determine an operation start time of a defrost heater, thereby reducing user misunderstanding related to performance degradation or failure of the refrigerator and improving the refrigeration efficiency of the refrigerator.

The refrigerator 1000 according to an embodiment may include the door 1110, the communication unit 1200, the heat exchanger 1310, the defrost heater 1320, and the at least one processor 1600. The at least one processor 1600 may determine a first time period during which the refrigerator 1000 is not used based on an opening and closing pattern of the door 1110 during the first period of time. The at least one processor 1600 may control the communication unit 1200 to receive sleep pattern information from the smart device 3000. The at least one processor 1600 may control the communication unit 1200 to transmit, to the server 2000, the first time period and the sleep pattern information. The at least one processor 1600 may control the communication unit 1200 to receive, from the server 2000, a second time period obtained by calibrating the first time period based on the sleep pattern information. The at least one processor 1600 may determine when to start operating the defrost heater 1320 based on a cooling duration of the heat exchanger 1310 and the second time period.

In an embodiment, the at least one processor 1600 may operate the defrost heater 1320 during at least a portion of the second time period.

According to an embodiment, the at least one processor 1600 may determine, as the first point in time, the operation start time of the defrost heater 1320 when the first point in time at which the cooling duration ends is included in the second time period.

According to an embodiment, the at least one processor 1600 may determine, as the second point in time as a start point in time of the second time period, the operation start time of the defrost heater 1320 when the first point in time at which the cooling duration ends is not included in the second time period.

In an embodiment, the at least one processor 1600 may determine the operation start time as a second point in time after the first point in time when the second point in time is reached before a threshold time after the first point in time.

In an embodiment, the at least one processor 1600 may determine the operation start time as a second point in time before the first point in time when the second point in time is reached after a threshold time after the first point in time.

In an embodiment, the first period of time may be 5 days or more to 7 days or less, including weekdays and weekends. The at least one processor 1600 may obtain an opening and closing pattern of the door 1110 on a daily basis during the first period of time.

In an embodiment, the at least one processor 1600 may control the communication unit 1200 to establish a Bluetooth low energy (BLE) communication connection with the smart device 3000. The at least one processor 1600 may control the communication unit 1200 to receive the sleep pattern information from the smart device 3000 that has established a BLE communication connection.

In an embodiment, the at least one processor 1600 may control the communication unit 1200 to receive the sleep pattern information from the smart device 3000 at a specified interval. The specified interval may be 1 day.

In an embodiment, the at least one processor 1600 may control the communication unit 1200 to receive the sleep pattern information from the smart device 3000 in response to a user input. The user input may be a touch input entered into the input interface 1420 installed on a front surface of the door 1110 of the refrigerator 1000 or the smart device 3000.

The method of controlling the refrigerator 1000 according to an embodiment may include determining a first time period during which the refrigerator 1000 is not used based on an opening and closing pattern of the door 1110 during a first period of time. The method of controlling the refrigerator 1000 may include receiving sleep pattern information from the smart device 3000. The method of controlling the refrigerator 1000 may include transmitting, to the server 2000, information on the first time period and the sleep pattern information. The method of controlling the refrigerator 1000 may include receiving, from the server 2000, the second time period obtained by calibrating the first time period based on the sleep pattern information. The method of controlling the refrigerator 1000 may include determining an operation start time of the defrost heater 1320 of the refrigerator 1000 based on a cooling duration of the heat exchanger 1310 of the refrigerator 1000 and the second time period.

In an embodiment, the determining of the operation start time of the defrost heater 1320 may include suppressing an operation of the defrost heater 1320 during the second time period.

In an embodiment, the determining of the operation start time of the defrost heater 1320 may include determining, as the first point in time, the operation start time of the defrost heater 1320 when the first point in time at which the cooling duration ends is included in the second time period.

In an embodiment, the determining of the operation start time of the defrost heater 1320 may include determining, as the second point in time that is a start time of the second time period, the operation start time of the defrost heater 1320 when the first point in time at which the cooling duration ends is not included in the second time period.

In an embodiment, the determining of the operation start time of the defrost heater 1320 may include determining the operation start time as the second point in time after the first point in time when the second point in time is reached before a threshold time after the first point in time.

In an embodiment, the determining of the operation start time of the defrost heater 1320 may include determining the operation start time as the second point in time before the first point in time when the second point in time is reached after a threshold time after the first point in time.

In an embodiment, the first period of time may be 5 days or more to 7 days or less, including weekdays and weekends. The determining of the first time period during which the refrigerator 1000 is not used may include obtaining the opening and closing pattern of the door 1110 on a daily basis during the first period of time.

In an embodiment, the receiving of the sleep pattern information from the smart device 3000 may include establishing a Bluetooth low energy (BLE) communication connection with the smart device 3000. The receiving of the sleep pattern information from the smart device 3000 may include receiving the sleep pattern information from the smart device 3000 that establishes a BLE communication connection.

In an embodiment, the receiving of the sleep pattern information from the smart device 3000 may include receiving the sleep pattern information from the smart device 3000 at a specified interval. The specified interval may be 1 day.

In an embodiment, the receiving of the sleep pattern information from the smart device 3000 may include receiving the sleep pattern information from the smart device 3000 in response to a user input. The user input may be a touch input entered into the input interface 1420 installed on a front surface of the door 1110 of the refrigerator 1000 or the smart device 3000.

A method according to an embodiment of the present disclosure may be implemented in the form of program commands that may be executed through various computer devices and recorded in a computer-readable medium. The computer-readable medium may include a program command, a data file, and a data structure alone or in combination. The program commands recorded in the medium may be those specifically designed and configured for the present disclosure or may be known and available to those of skill in the art of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code generated by a compiler and a high-level language code executable by a computer using an interpreter and the like.

Some embodiments of the present disclosure may also be implemented in the form of a recording medium containing computer-executable instructions, such as program modules executed by a computer. Computer-readable media may be any available media that are to be accessed by a computer, and includes both volatile and nonvolatile media, removable and non-removable media. Computer-readable media may include both computer storage media and communication media. Computer storage media includes both volatile and nonvolatile, removable and non-removable media implemented in any method or technology for storage of information such as computer-readable instructions, data structures, program modules or other data. Communication media typically include computer readable instructions, data structures, program modules, or other data in a modulated data signal such as a carrier wave, or other transport mechanism, and includes any information delivery media. Some embodiments of the present disclosure may also be implemented as a computer program or computer program product including computer-executable instructions, such as a computer program executed by a computer.

The device-readable storage medium may be provided in the form of a non-transitory storage medium. Here, the term ‘non-transitory storage medium’ simply means a tangible device that does not contain signals (e.g. electromagnetic waves), and the term does not distinguish between cases in which data is stored semi-permanently or temporarily on a storage medium. For example, the ‘non-transitory storage medium’ may include a buffer in which data is temporarily stored.

According to an embodiment, the methods according to various embodiments disclosed in the document may be provided as included in a computer program product. The computer program product may be traded between sellers and buyers as commodities. The computer program product may be distributed in the form of a device-readable storage medium (e.g., a compact disc read only memory (CD-ROM)), or may be distributed online (e.g., by download or upload) via an application store or directly between two user devices (e.g., smartphones). In the case of online distribution, at least a portion of the computer program product (e.g., a downloadable app) may be temporarily stored or temporarily generated in a device-readable storage medium, such as the memory of a server of a manufacturer, a server of an application store, or an intermediary server.

1. A refrigerator comprising:
a door;
a communication unit;
a heat exchanger;
a defrost heater; and
at least one processor configured to:
determine a first time period during which the refrigerator is unused based on an opening and closing pattern of the door during the first time period,
control the communication unit to receive sleep pattern information from a smart device, control the communication unit to transmit, to a server, the first time period and the sleep pattern information,
control the communication unit to receive, from the server, a second time period obtained by calibrating the first time period based on the sleep pattern information, and
determine an operation start time of the defrost heater based on a cooling duration of the heat exchanger and the second time period.

2. The refrigerator of claim 1, wherein the at least one processor is configured to operate the defrost heater during at least a portion of the second time period.

3. The refrigerator of claim 1, wherein, based on a point in time at which the cooling duration ends being within the second time period, the at least one processor is configured to determine, as the point in time, the operation start time of the defrost heater.

4. The refrigerator of claim 1, wherein, based on a first point in time at which the cooing duration ends not being within the second time period, the at least one processor is configured to determine, as a second point in time that is a start time of the second time period, the operation start time of the defrost heater.

5. The refrigerator of claim 4, wherein, based on the second point in time being reached before a threshold time after the first point in time, the at least one processor is configured to determine the operation start time as the second point in time after the first point in time.

6. The refrigerator of claim 4, wherein, based on the second point in time being reached after a threshold time after the first point in time, the at least one processor is configured to determine the operation start time as the second point in time before the first point in time.

7. The refrigerator of claim 1, wherein the first time period indicates 5 days or more to 7 days or less, including a weekday and a weekend, and
the at least one processor is configured to obtain the opening and closing pattern of the door on a daily basis during the first period of time.

8. The refrigerator of claim 1, wherein the at least one processor is configured to control the communication unit to establish a Bluetooth low energy (BLE) communication connection with the smart device, and control the communication unit to receive the sleep pattern information from the smart device that has established the BLE communication connection.

9. The refrigerator of claim 1, wherein the at least one processor is configured to control the communication unit to receive the sleep pattern information from the smart device at a specified interval, and the specified interval indicates 1 day.

10. The refrigerator of claim 1, wherein the at least one processor is configured to control the communication unit to receive the sleep pattern information from the smart device in response to a user input, and
the user input is a touch input entered into an input interface installed on a front surface of the door of the refrigerator or the smart device.

11. A method of controlling a refrigerator, the method comprising:
determining a first time period during which the refrigerator is unused based on an opening and closing pattern of a door during the first time period,
receiving sleep pattern information from a smart device;
transmitting, to a server, the first time period and the sleep pattern information;
receiving, from the server, a second time period obtained by calibrating the first time period based on the sleep pattern information; and
determining an operation start time of a defrost heater of the refrigerator based on a cooling duration of a heat exchanger of the refrigerator and the second time period.

12. The method of claim 11, wherein the determining of the operation start time of the defrost heater includes suppressing an operation of the defrost heater during the second time period.

13. The method of claim 11, wherein the determining of the operation start time of the defrost heater includes, based on a first point in time at which the cooling duration ends being within the second time period, determining, as the first point in time, the operation start time of the defrost heater.

14. The method of claim 11, wherein the determining of the operation start time of the defrost heater includes, based on a first point in time at which the cooling duration ends not being within the second time period, determining, as a second point in time that is a start time of the second time period, the operation start time of the defrost heater.

15. The method of claim 14, wherein the determining of the operation start time of the defrost heater includes, based on the second point in time being reached before a threshold time after the first point in time, determining the operation start time as the second point in time after the first point in time.
